(19) United States
(12) Patent Application Publication
(10) Pub. No.: US 2002/0128903 A1
(43) Pub. Date: Sep. 12, 2002

(54) ENCRYPTED COUPONS

(76) Inventor: KENT KERNAHAN, CUPERTINO, CA (US)

Correspondence Address: SKJERVEN MORRILL MACPHERSON LLP, 25 METRO DRIVE, SUITE 700, SAN JOSE, CA, 95110, US

(21) Appl. No.: 09/379,554

(22) Filed: Aug. 23, 1999

(51) Int. Cl. G06F 17/60

(52) U.S. Cl. 705/14

(57) ABSTRACT

A system and a method transmits the electronic coupon to a personal digital assistant (“PDA”), for use. Prior to transmitting the electronic coupon, the computer may encrypt the electronic coupon. A consumer next displays the electronic coupon on the PDA to a merchant and the merchant gives the appropriate discount to the consumer. The electronic coupon can be displayed on the PDA with an electronic coupon application. To redeem the electronic coupon, a merchant may be required to enter a passphrase to verify the contents of the electronic coupon. Sometimes an activation agent also may also be required to enter a passphrase to activate the electronic coupon. In another system, the server links the electronic coupon to a geographic location on an electronic map. The electronic map is displayed on the PDA by the electronic coupon application. Whenever a geographic location linked to an encrypted coupon is displayed, the electronic coupon application displays an icon of the electronic coupon. Furthermore, the consumer can perform a coupon search in the map application to find the electronic coupon. In addition, advertising fees for the merchants can be base on the number of times a coupon is displayed, activated, and redeemed.

### CROSS REFERENCE TO ATTACHED APPENDICES

Appendix A, which is a part of the present disclosure, is a microfiche appendix consisting of a total of 296 pages (including cover). Appendix A is a listing of computer programs and related data for displaying maps and coupons on a personal digital assistant, which is described more completely below.

Appendix B, which is a part of the present disclosure, is a microfiche appendix consisting of a total of 159 pages (including cover). Appendix B is a listing of computer programs and related data for converting a US Census map database into a map database used by the computer programs of Appendix A, which is described more completely below.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND

Coupons are commonly used by buyers to obtain discounts on goods or services being purchased. Frequently, such a coupon is part of a printed advertisement, and the coupon needs to be torn off and presented to the merchant to obtain the discount.

Of late, coupons have become available on the Internet. For example, the web site http://www.times-news.com/coupons/ec.html discloses coupons that are made available for printing, and the printed coupons are thereafter used in the normal manner. See also http://www.coupondirectory.com.

An article entitled “Would you like ads on mobile phone?” in San Jose Mercury News, on Jul. 7, 1999 states “[o]n the road in an unfamiliar city, you might be willing to pay for driving directions to the nearest hotel—particularly if they were zapped to your cell phone or hand-held computer.” (See column 2, first paragraph). The article further states “[t]he carriers are being prodded by a slew of high-tech firms with wireless data technologies, including ways to let users trade stocks or participate in online auctions, check their corporate databases, or even receive electronic coupons they can use in nearby stores.” (See column 3, first paragraph).

### SUMMARY

The present invention relates to a system and a method for using coupons in electronic form (also called “electronic coupons”). In one embodiment a computer transmits an electronic coupon to a hand-held computer, such as a personal digital assistant (“PDA”), and the hand-held computer displays the electronic coupon. When the displayed electronic coupon is presented to a merchant, the merchant gives an appropriate discount (e.g. for an amount indicated on the electronic coupon). Note that such an electronic coupon need not be printed, unlike the electronic coupons described (above) in certain prior art references. Electronic processing of such coupons, from generation to redemption has a number of advantages, including but not limited to: saving paper, reducing fraud, customization based on user interest and geography, and statistical analyses of consumer demographics and behavior.

A coupon of the type described herein can be a representation of data enabling a user to obtain a benefit from a merchant. It is also a method of conveying an offer from a merchant to a user with restrictions as to the timing, use and duplication of the offer so as to reduce the possibility of unauthorized use of the coupon conveying the offer. Such a coupon performs its function through the use of a collection of elements and cryptography (for example public key cryptography). By selectively granting access to each element by each party to the transaction, the coupon enables value to be conveyed securely from the merchant to the user with a great deal of flexibility. Use tracking elements associated with the coupon permit marketing promotions programs to be designed with fees directly related to each aspect of the transaction from viewing of an icon through redemption of the coupon.

In one embodiment, a server coupled to the Internet generates an electronic coupon in accordance with one or more specifications provided by a merchant, such as a manufacturer of an item (or a service provider of a service) on which the discount is being provided. Depending on the implementation, such a merchant can either submit such specifications to the server via the Internet, or submit the specifications to an operator of the server through the mail or on the telephone. After an electronic coupon has been generated, a consumer downloads the electronic coupon to the PDA (either directly from the server, or indirectly via a computer that is colocated relative to the consumer and that is coupled to the server). An electronic coupon in the PDA can be displayed by software (called “electronic coupon application”) running in the PDA.

In another embodiment, the server encrypts the electronic coupon using public key cryptography. The encryption allows the consumer to view only a first portion of the encrypted coupon. When the consumer presents the displayed coupon to the merchant, the merchant enters a passphrase (either directly on the PDA or on a computer that is colocated relative to the merchant) that decrypts a second portion of the encrypted coupon. The passphrase may be entered either manually (e.g. if the merchant is a human) or automatically (e.g. if the merchant is represented by a computer). Upon verifying that the content of the second portion of the encrypted coupon matches specifications previously provided for generation of the coupon, the merchant gives the appropriate discount to the consumer, and marks the encrypted coupon as redeemed.

In yet another embodiment, the consumer first presents an encrypted coupon (located in the PDA) to a third party (called “activation agent”; which can be a human being or another computer depending on the implementation). In this embodiment, the activation agent activates the encrypted coupon, before the merchant redeems the encrypted coupon. In one implementation, when the consumer presents the encrypted coupon on the PDA to the activation agent, the activation agent enters a passphrase that decrypts a third portion of the encrypted coupon. As before, the passphrase may be entered either manually or automatically. Upon verifying the content of the third portion of the encrypted coupon, the activation agent marks the coupon as activated.

In one embodiment, a merchant who wishes to submit specifications for an encrypted coupon registers with the server and and provides billing information. As before, the merchant can register with the server through the Internet, or via mail or on the telephone. Similarly, a consumer who wishes to download an encrypted coupon may also register with the server (preferably, but not necessarily via the Internet) and provide demographic information (e.g. for use in statistical analyses).

In one embodiment, the server links the electronic coupon to a geographic location on an electronic map. The electronic map may include maps of a city, a shopping mall, a store, or a convention in a convention center. In this embodiment, the server may also encrypt the electronic coupon. The consumer downloads the electronic map to the PDA and uses the software (called “electronic coupon application”) on the PDA to access the electronic map and the encrypted coupon. Whenever a geographic location linked to an encrypted coupon is displayed, the electronic coupon application also displays an icon of the electronic coupon. The consumer can find additional information about the electronic coupon by selecting the icon shown on the PDA display. Furthermore, the consumer can perform a coupon search in the PDA to find an electronic coupon that the consumer wishes to redeem. Moreover, the server may calculate advertising fees according to the number of times a coupon is displayed, activated, and redeemed.

### BRIEF DESCRIPTION OF THE DRAWINGS

FIG. 1 illustrates, in a high level block diagram, use of a hand-held computer to display an electronic coupon, and showing of the displayed coupon by a consumer to a merchant for redemption in accordance with the invention.

FIG. 2 illustrates, in a high level flow chart, various operations performed in one embodiment to implement the system illustrated in FIG. 1.

FIG. 2A illustrates an electronic coupon that is being displayed by the consumer to the merchant as illustrated in FIG. 1.

FIG. 3 illustrates, in a flow chart, various operations performed in another embodiment of the invention.

FIG. 4 illustrates, in an intermediate level block diagram, one embodiment of the system illustrated in FIG. 1.

FIG. 5 illustrates, in an intermediate level flow chart, operations performed by the system illustrated in FIG. 4.

FIG. 6 illustrates, fields in a data structure used to access memory that holds elements of information related to an electronic coupon in one embodiment.

FIG. 7 illustrates, in various elements provided by a merchant for use in generating an electronic coupon

FIGS. 8 and 9 illustrate an authentication element used by a merchant and an activation agent respectively to verify the authenticity of a displayed coupon.

FIG. 10 illustrates a tracking element that holds information related to how the coupon was viewed and used, for statistical analyses and also for billing.

FIG. 11 illustrates a control element that identifies various conditions required for redemption of a coupon (including whether or not the coupon has been redeemed).

FIG. 12 illustrates a data structure used to access memory holding a coupon, with fields indicating access rights regarding data held in the coupon.

FIG. 13 illustrates a flow chart of operations performed during interaction between the merchant using client computer 44 and web server 42 during merchant registration.

FIG. 13A illustrates a form in a web page used for registration of merchants, prior to allowing merchants to provide information for generation of coupons.

FIG. 14 illustrates, in a flow chart, interaction between the merchant using client computer 44 and web server 42 during the submission of coupon specifications.

FIG. 14A illustrates a form in a web page for use by a merchant to provide specifications for a coupon.

FIG. 15 illustrates, in a flow chart, interaction among a consumer using client computer 44, web server 42, and PDA 48 during consumer registration.

FIG. 15A illustrates a form in a web page for registration of a consumer prior to allowing a consumer to download electronic coupons.

FIG. 16 illustrates, in a flow chart, interaction between the consumer using electronic coupon application 106 on PDA 48 and the merchant during the redemption of an encrypted coupon 123.

FIG. 17 illustrates a coupon 300 displayed on PDA 48, with a redeem button to allow electronic redemption by a merchant.

Note that use of the same reference numbers in different figures indicates the same or like elements.

### DETAILED DESCRIPTION

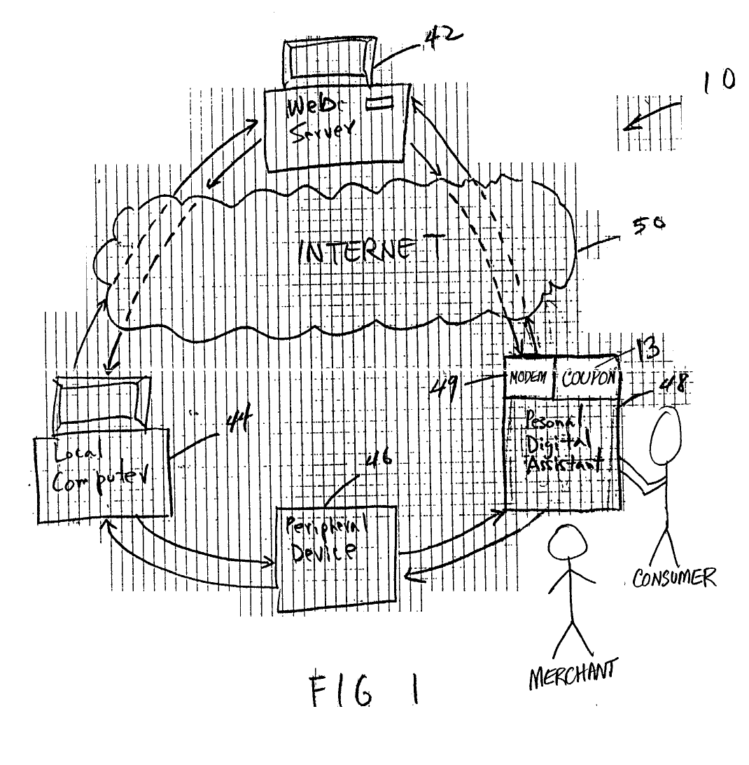

FIG. 1 illustrates a high level block diagram of an embodiment of an electronic coupon system 10 in one embodiment of the invention. Electronic coupon system 10 includes a web server 42, a client computer 44, a PDA 48 (such as Palm/Win CE), and access to the Internet 50. The coupons are dispayed by PDA 48, and can be used by any consumer, such as business and pleasure travelers.

Such coupons can be proximity invoked (depending on the location of the consumer relative to the merchant), time expiring (having a expiry date after which they cannot be redeemed), encrypted (so that they cannot be duplicated without authorization), redeemable electronically (so that there is no need to print the coupons), exchangeable (so that consumers can trade with each other) and linked to navigation (so that the coupons are presented with a map for use with merchants shown on the map).

Coupons as described herein can precisely target advertising to consumers, in a manner similar to browsers, because each consumer's demographics information is known (obtained either during registration or by collection over time based on use of such coupons). The coupons can be used to sell goods or services in accordance with the “just in time” method in marketing, because a merchant can upload coupons as and when, for example, inventory builds up. Moreover, system 10 reduces fraud because consumers will not be able to easily decrypt coupons that have been encrypted.

A consumer can simply read a coupon (or an advertisement) displayed by PDA 48, check the location with the built in map software, physically go to the location, show the displayed coupon in PDA 48 to a merchant at the location and have the merchant redeem the coupon. Therefore, an electronic coupon as described herein need not be handled physically (e.g. no cutting, no purchasing a magazine/newspaper, no directions needed, no need to remember to bring the coupon). Instead, the coupon is handled automatically, and its use is as easy as turning on the PDA.

System 10 can be provided to consumers in a free High Value Personal Navigation Package (e.g. $50 for registration at which time software of the type described herein is provided). The consumer's PDA may also be equipped with GPS hardware (e.g. at a cost of $300) and map modules (e.g. at a cost of $100). Note that in system 10, PDA 48 may be coupled only occasionally to Internet 50, thereby eliminating the need for full time connection to the Internet 50 (at least for coupon download).

Merchants can be charged a setup fee for display of coupons based on the number of installed devices (in a manner similar to print subscriptions). Merchants can also be charted a per click fee based on actual viewing (in a manner similar to internet banners). Yet another way for charging merchants can be related to the number of coupons redeemed (like coupon clearing), or to the percentage of transaction on coupons redeemed (like credit card discount). System 10 as described herein allows advertisers to target a mobile user where they “live,”

pay for real users (by paying only for “hits”), and build a data base of frequent users. Therefore, no longer will advertisers have to pay for space that “wraps fish.”

System 10 provides proof of advertising to the advertiser (e.g. in the form of coupons that have been redeemed), and therefore provide information on the return on investment that is not available in several prior art methods of advertisement. Moreover, advertisements can be offered free for a period of time (say 90 days) to offer proof to an advertiser that system 10 works. Moreover, coupons that are provided selectively to consumers, e.g. based on demographics match or consumer's location provides targeted advertising of the type not available in many conventional media.

A suitable web server 42 includes an input/output (“I/O”) adapter, central processing unit (“CPU”) (e.g., a microprocessor), and a memory. A suitable web server 42 is for example a Solaris Server available from SUN Microsystems that uses either Microsoft NT 4.0, IIS or UNIX OS. Those skilled in the art will appreciate that the present invention may also be implemented on platforms and operating systems other than those mentioned above. Hereafter the term “web server 42” includes the software executed by web server 42. Software executed by web server 42 will be described in more detail later.

A suitable client computer 44 includes a typical personal computer (“PC”) having an I/O adapter, a CPU (e.g., a microprocessor), and a memory. A typical PC is for example a commercially available IBM PS/2 personal computer, Apple Macintosh computer, or UNIX-based workstation. The PC further includes a display such as a computer monitor of a super VGA type or other visual display device.

Client computer 44 typically has resident thereon an operation system (“OS”) such as Microsoft Windows NT™ or Microsoft Windows 95™, IBM OS/2, the Apple MAC OS, or UNIX OS such as the HP-UX OS. Those skilled in the art will understand that the present invention may also be implemented on platforms and operating systems other than those mentioned above.

Client computer 44 can use a web browser, such as Microsoft Internet Explorer or Netscape Navigator, to access a server of a web page with textual and graphical contents (e.g., web server 42). To specify a web site, the user enters a universal resource locator (“URL”) specifying both the server and the specific data (e.g., web page) requested.

The URL may specify a hyper-text transfer protocol (“HTTP”) or another transfer protocol for communicating between the server and the browser. Using the Internet 50, the URL is transmitted to the server which stores information corresponding to the URL. Hereafter, the term “client computer 44” includes the software executed by client computer 44. Software executed by client computer 44 will be described in more detail later.

A suitable PDA 48 includes an I/O adapter, CPU (e.g., a microprocessor), and a memory. A suitable PDA 48 is for example one of the Palm computing platforms made by 3Com of Santa Clara, Calif.

PDA 48 typically has resident thereon an operating system such as Palm OS™ and Window CE. Those skilled in the art will appreciate that the present invention may also be implemented on platforms and operating systems other than those mentioned above. Hereafter, the term “PDA 48” includes the software executed by PDA 48. Software executed by PDA 48 will be described in more detail later.

PDA 48 can transfer data with client computer 44 through a peripheral device 46. A suitable peripheral device includes a HotSync® cradle, a HotSync® cable, a telephone modem, and an infrared port. Alternatively, PDA 48 can have a communication link with the Internet 50 through a telephone modem or a built-in wireless modem 49. A suitable PDA 48 with a wireless modem 49 is for example Palm VII™ made by 3Com of Santa Clara, Calif.

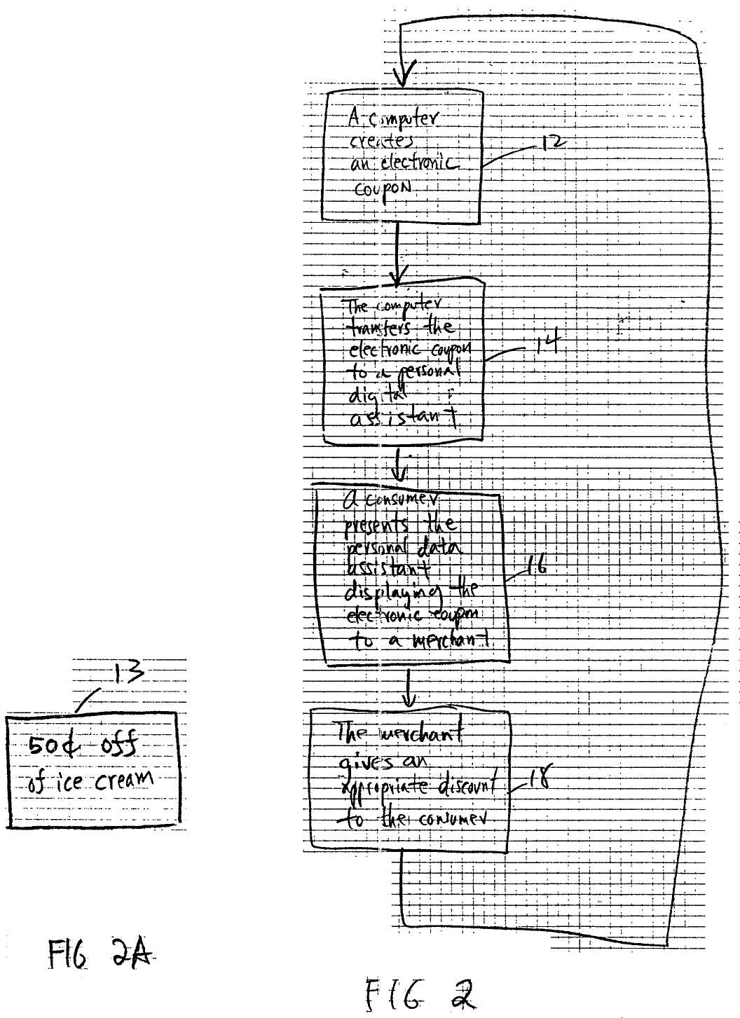

FIG. 2 illustrates a flow chart of electronic coupon 10 of FIG. 1.

In action 12, client computer(also called local computer) 44 creates an electronic coupon. FIG. 2A illustrates an example of an electronic coupon 13. A suitable electronic coupon 13 is a bit-mapped file representing text and graphics. Alternatively, a suitable electronic coupon 13 is an ASCII file representing text. Those skilled in the art will understand that electronic coupon 13 may be created and saved in other text and graphical formats.

In action 14, client computer 44 transfers electronic coupon 13 to PDA 48. As previously described, client computer 44 can transfer data, e.g., electronic coupon 13, to PDA 48 through peripheral device 46. In one embodiment, PDA 48 is one of the Palm computing platforms, such as Palm III™, Palm V™, and Palm VII™, made by 3Com of Santa Clara, Calif. As such, client computer 44 can transfer electronic coupon 13 to PDA 48 through a HotSync® cradle, a HotSync® cable, a telephone modem, or an infrared port.

In action 16, a consumer presents PDA 48 displaying the electronic coupon to a merchant. PDA 48 includes an electronic coupon application that displays electronic coupon 13. A suitable electronic coupon application is a text or graphical application that can read ASCII or bit-mapped files, respectively. Those skilled in the art will understand that electronic coupon application can be a text or graphical application that reads other text and graphical formats. In action 18, the merchant gives an appropriate discount to the consumer.

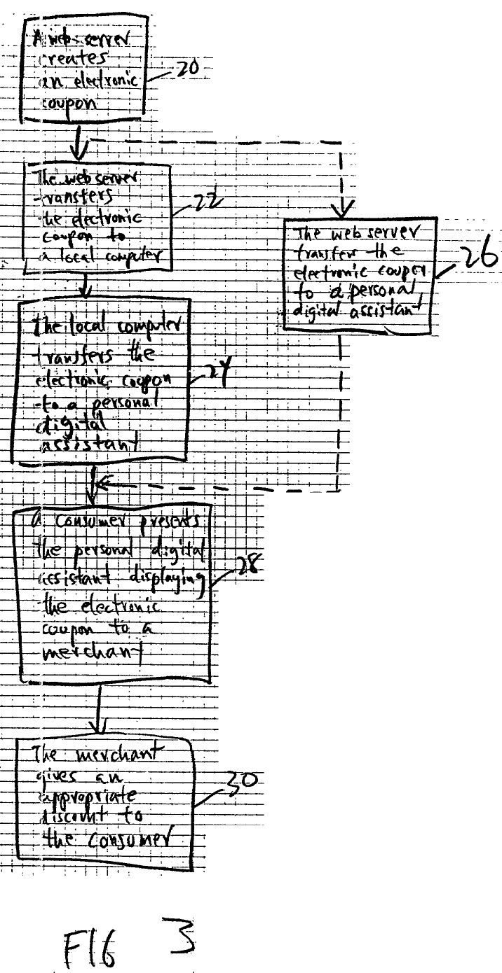

FIG. 3 illustrates a flow chart of another embodiment of electronic coupon system 10 illustrated in FIG. 1. In action 20, web server 42 creates electronic coupon 13 according to the specifications of a merchant. As previously described, one skilled in the art will understand that electronic coupon 13 can be created in various text and graphical formats.

The merchant may submit the specifications of electronic coupon 13 to web server 42 via the Internet 50. For example, the merchant can use client computer 44 to access a specification web page stored on web server 42 to enter the specifications of electronic coupon 13. Web server 42 then saves the coupon specifications on a coupon database.

Alternatively, the merchant may submit the specifications of the coupon through the mail or on the telephone to the operators of web server 42. The operators then enter the coupon specifications into the coupon database of web server 42.

In action 22, web server 42 transfers electronic coupon 13 to client computer 44. The file transfer between web server 42 and client computer 44 may occur through File Transfer Protocol (“FTP”), a protocol used on the Internet for transferring files that is well understood by those skilled in the art.

In action 24, client computer 44 transfers electronic coupon 13 to PDA 48. As previously described, client computer 44 can transfer data, e.g., electronic coupon 13, to PDA 48 through peripheral devices 46.

Alternatively, action 26 replaces actions 22 and 24. In action 26, web server 42 transfers the electronic coupon to PDA 48 via the Internet 50. As previously described, PDA 48 may have a communication link with the Internet through a telephone modem or a built-in wireless modem 49. Thus, web server 42 may transfer electronic coupon to PDA 48 through a communication link on the Internet 50.

In action 28, the consumer presents PDA 48 displaying electronic coupon 13 to the merchant. As previously described, those skilled in the art will understand that PDA 48 may include an electronic coupon application that displays the text or graphical formats of electronic coupon 13. In action 30, the merchant gives the consumer the appropriate discount according to the electronic coupon.

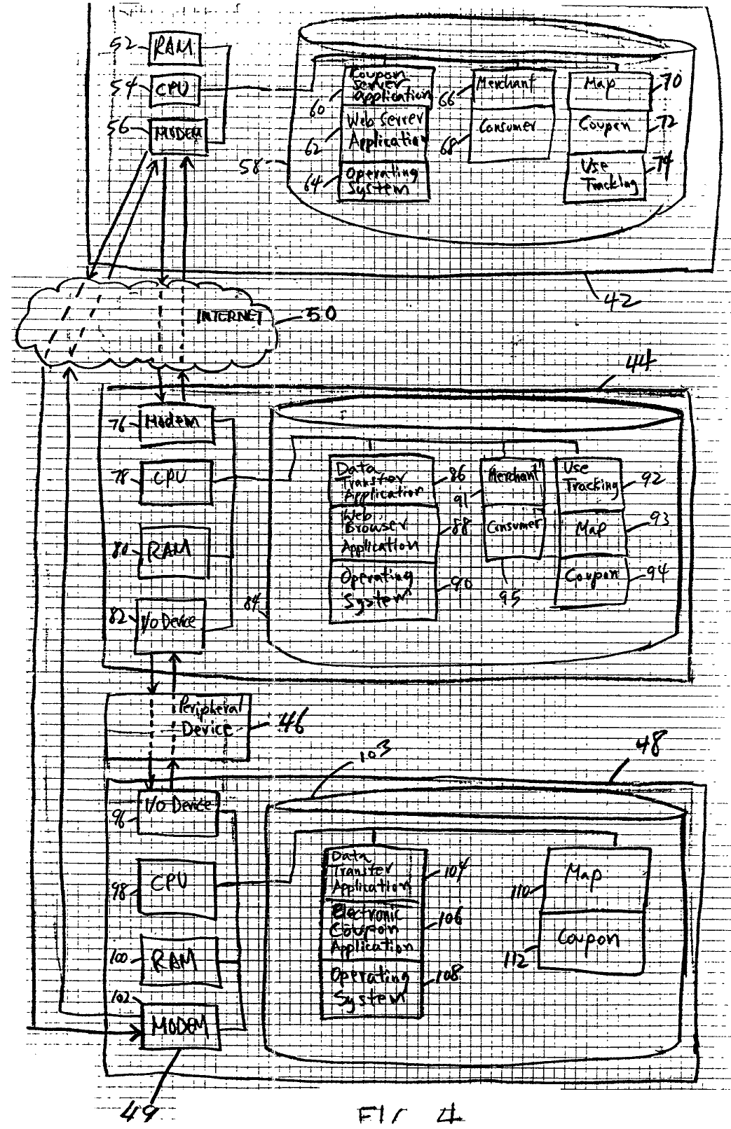

FIG. 4 illustrates a block diagram of another embodiment of electronic coupon system 10 in accordance with the present invention. Electronic coupon system 10 includes web server 42, client computer 44, PDA 48, and the Internet 50.

As shown in FIG. 4, web server 42 includes random access memory (“RAM”) 52, CPU 54, a modem 56, and a storage device 58. Storage device 58 includes a coupon server application 60, a web server application 62, an OS 64, a merchant database 66, a consumer database 68, a map database 70, a coupon database 72, and a use tracking database 74.

As shown in FIG. 4, client computer 44 includes modem 76, CPU 78, RAM 80, I/O device 82, and storage device 84. Storage device includes a data transfer application 86, a web browser application 88, an OS 90, a merchant database 91, a use tracking database 92, a map database 93, a coupon database 94, and a consumer database 95. A suitable data transfer application 86 is the HotSync® software for Palm computing platforms made by 3Com of Santa Clara, Calif.

As shown in FIG. 4, PDA 48 includes an I/O port 96, a CPU 98, a RAM 100, a modem 102, and a storage device 103. Storage device 103 includes a data transfer application 104, an electronic coupon application 106, an operating system 108, a map database 110, and a coupon database 112. A suitable data transfer application 104 is the HotSync® software for Palm computing platforms made by 3Com of Santa Clara, Calif.

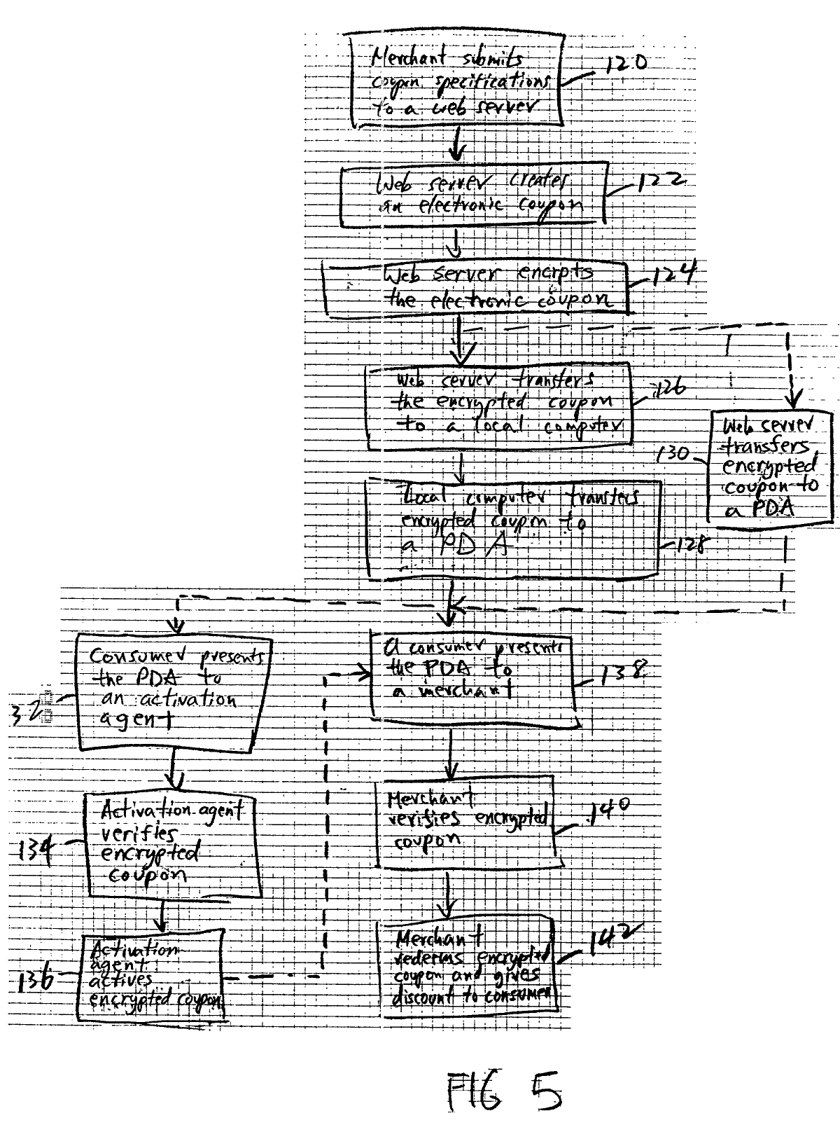

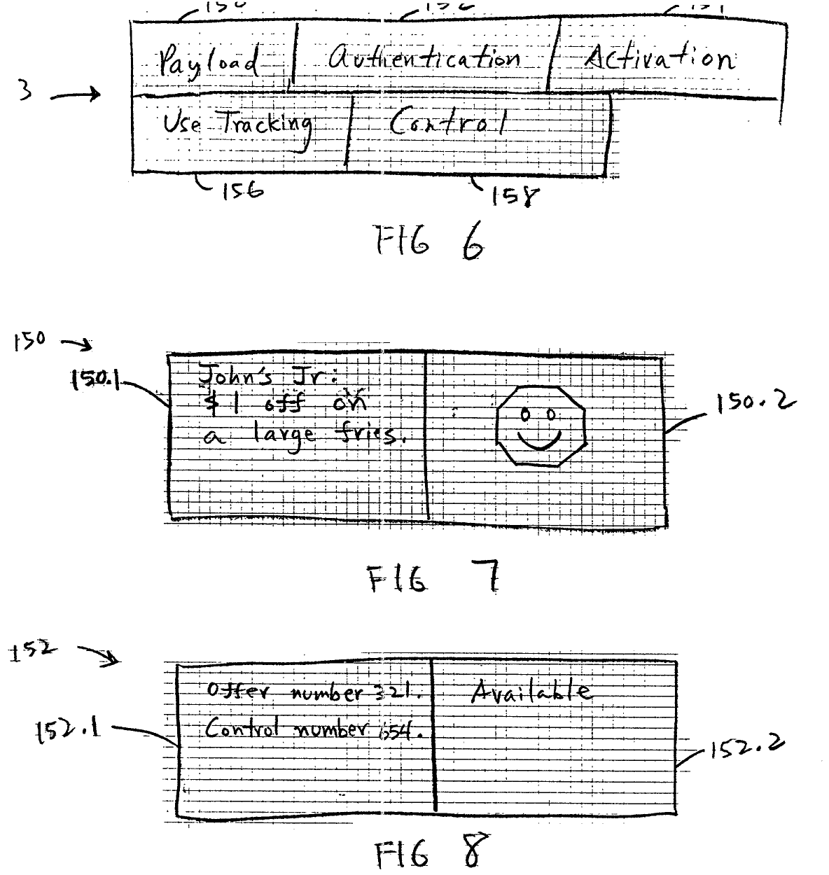

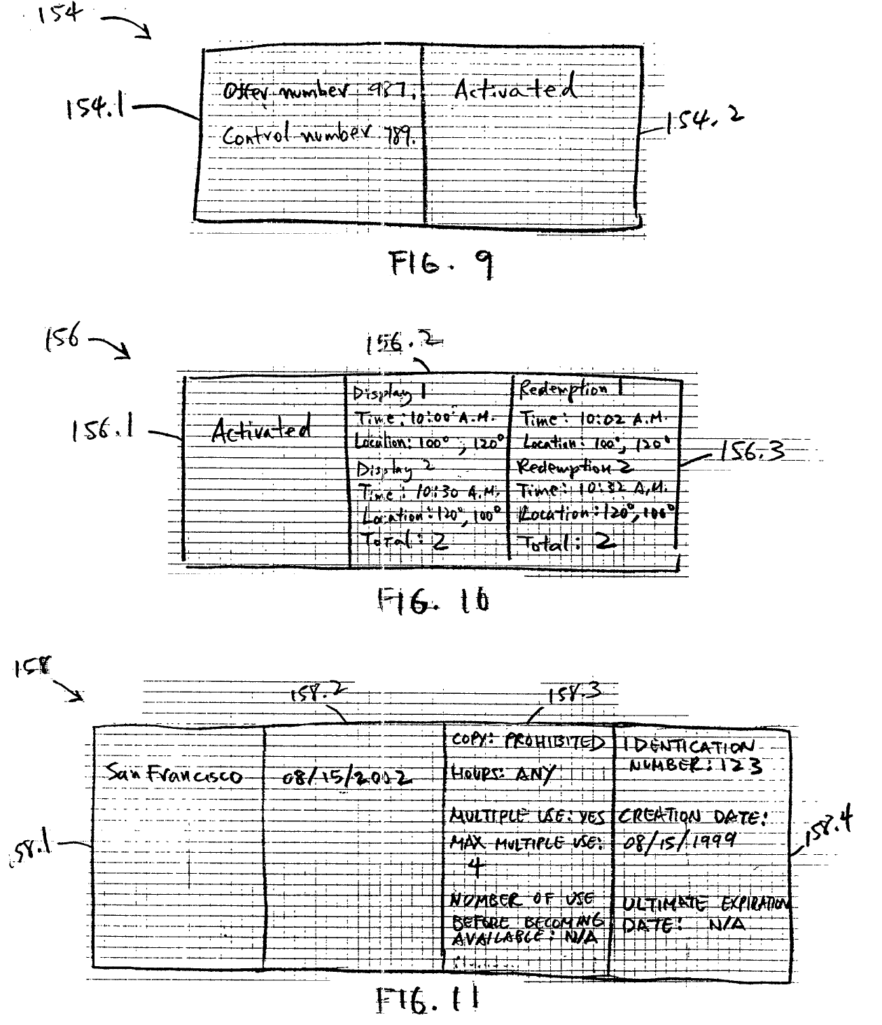

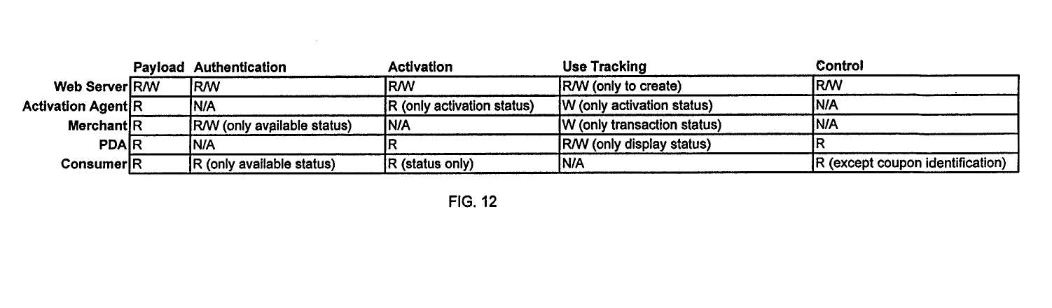

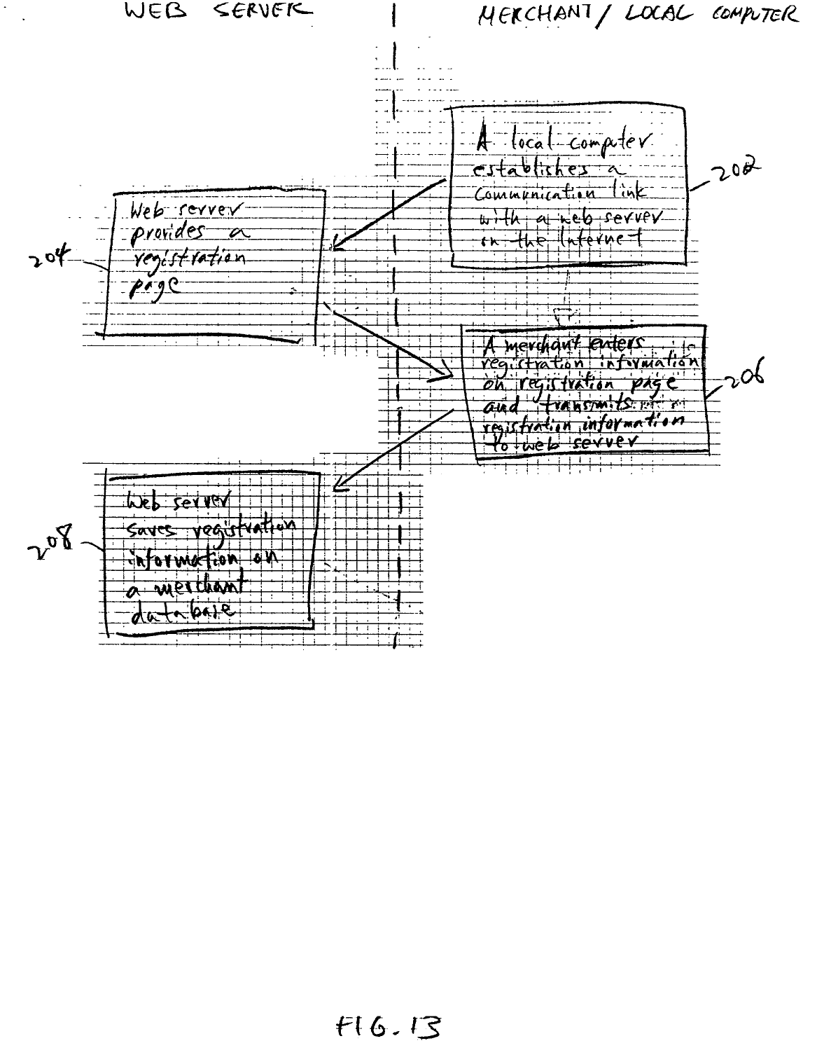

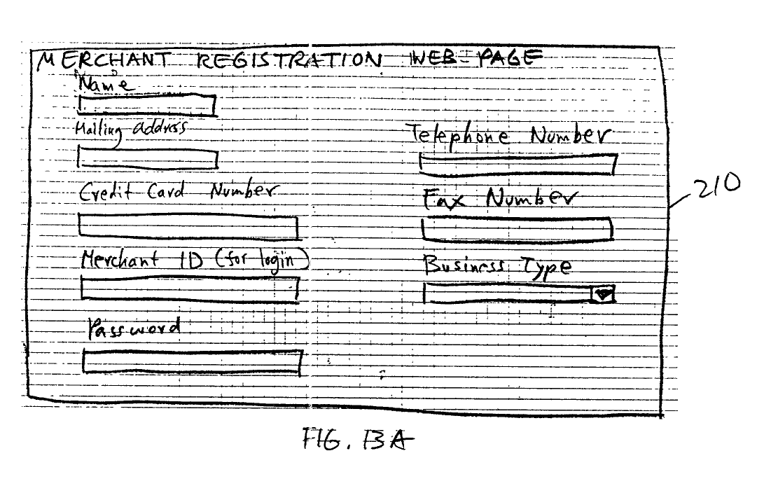

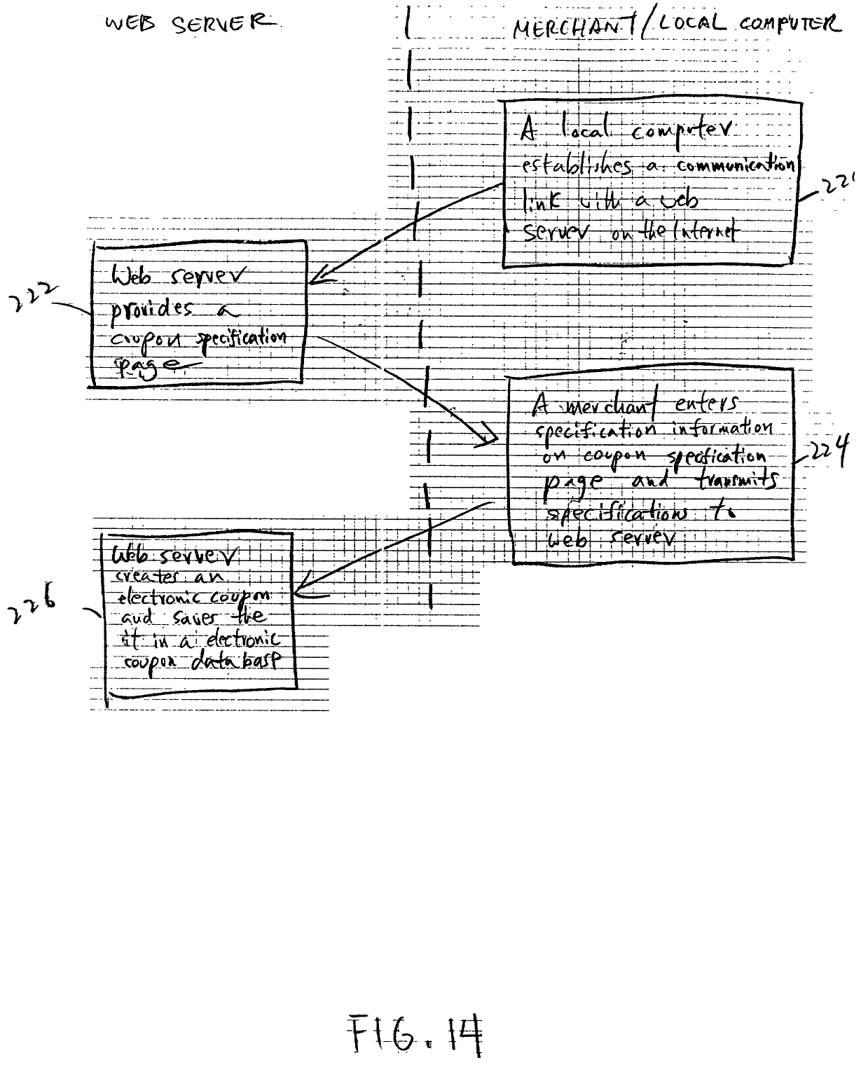

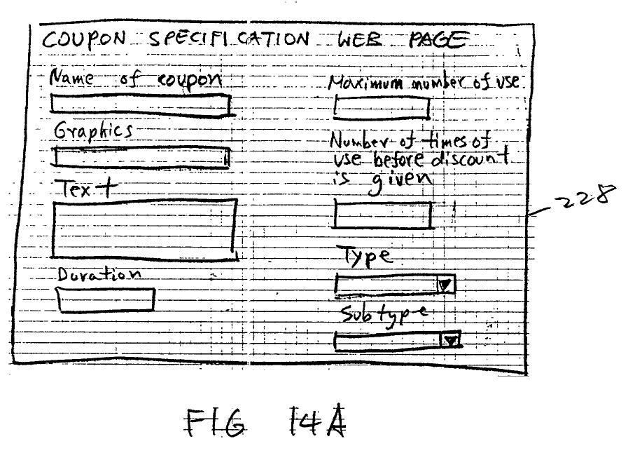

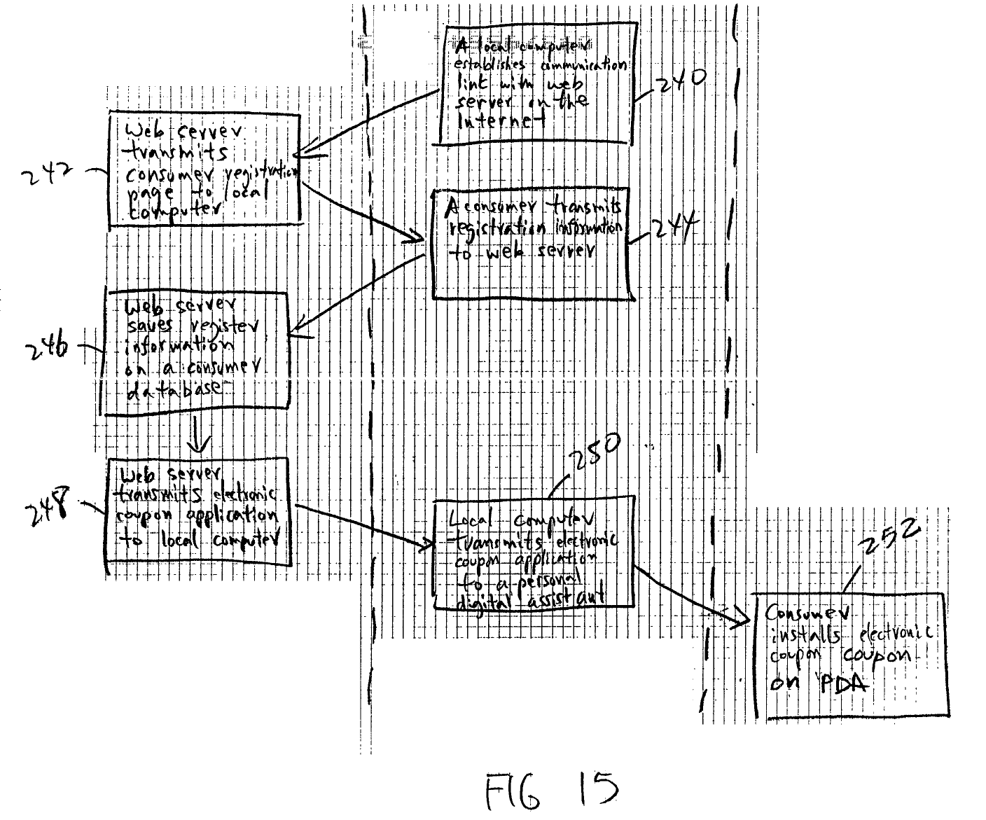

FIG. 5 illustrates a flow chart of an embodiment of the electronic coupon system 10 illustrated in FIG. 4. In action 120, a merchant submits coupon specifications to web server 42. As previously described, the merchant may submit the specifications to web server 42 via the Internet 50.

Alternatively, as previously described, the merchant may submit the specifications of the coupon through the mail or on the telephone to the operators of web server 42.

In action 122, web server 42 creates an electronic coupon 123 with coupon server application 60. Electronic coupon 123 will be described in detail later with respect to FIG. 6.

In action 124, web server 42 encrypts electronic coupon 123 with coupon server application 60. Coupon encryption will be described in detail later. Coupon server application 60 then saves encrypted coupon 123 in coupon database 72.

In action 126, web server 42 transfers encrypted coupon 123 to client computer 44. Web server 42 can transfer encrypted coupon 123 on the behest of a consumer or automatically when the consumer logs onto the Internet 50.

In action 128, client computer 44 transfers encrypted coupon 123 to PDA 48.

Alternatively, action 130 replaces actions 126 and 128. In action 130, web server 42 transfers encrypted coupon 123 to PDA 48. As previously described, PDA 48 may have an Internet connection that allows web server 42 to transfer encrypted coupon 123 to PDA 48 via the Internet 50. In this case, web server 42 can transfer encrypted coupon 123 on the behest of a consumer or automatically when the consumer logs onto the Internet 50 with PDA 48.

In another embodiment of electronic coupon 10, actions 132, 134, and 136 precede action 138. In action 132, a consumer presents PDA 48 to an activation agent. In action 134, activation agent verifies encrypted coupon 123. In action 134, activation agent activates encrypted coupon 123. In this embodiment, encrypted coupon 123 cannot be redeemed by a merchant unless it is first activated by an activation agent. Activation of encrypted coupon will be described in detail later.

In action 138, a consumer presents PDA 48 displaying encrypted coupon 123 to a merchant. In action 140, the merchant verifies encrypted coupon 123. In action 142, the merchant redeems the encrypted coupon and gives the consumer the appropriate discount. Redemption of encrypted coupon will be described in detail later.

The details of electronic coupon 123 will now be disclosed. FIG. 6 illustrates that a suitable electronic coupon 123 includes a payload element 150, an authentication element 152, an activation element 154, a use tracking element 156, and a control element 158.

Payload element 150 includes text element 150.1 and graphics element 150.2 that describe the face of the coupon. This element contains text and graphics, which describe the face of the coupon. This area may also contain information linking the Coupon to a particular geographic location (i.e. an address, a x,y,z offset with a site, a latitude/longitude or other coordinate system). This element contains text and graphics, which describe the face of the coupon. This area may also contain information linking the Coupon to a particular geographic location (i.e. an address, a x,y,z offset with a site, a latitude/longitude or other coordinate system). FIG. 7 illustrates a suitable payload element 150. The text element 150.1 and graphics element 150.2 of payload element conform with the specifications submitted by the merchant.

Authentication element 152 includes an authentication information element 152.1 and an available status element 152.2. FIG. 8 illustrates a suitable of authentication element 152.

Authentication information element 152.1 is used by a merchant to verify that the electronic coupon is genuine. Authentication information element 152.1 may contain information that only the merchant knows, such as an unique offer number or a control number. Available status element 152.2 indicates to PDA 48 and the consumer whether or not electronic coupon 123 is available for redemption.

Activation element 154 includes an activation information element 154.1 and an activation status element 154.2. The use model for some coupons requires that a third party (other than the user or the merchant) activate them prior to use. This element provides information and access for the activating agent to accomplish this model. FIG. 9 illustrates a suitable activation element 154.

Activation information element 154.1 is used by an activation agent uses to verify that the electronic coupon is genuine. Activation information element 154.1 may contain information that only the activation agent knows, such as an offer number or a control number. Activation status element 154.2 indicates to PDA 48, the consumer, and the merchant whether or not electronic coupon 123 is activated.

Use tracking element 156 includes an activation status element 156.1, display status element 156.2, and transaction status element 156.3. The display and use of coupons are tracked so that fees may be charged to advertisers based on the effectiveness of their offers. FIG. 10 illustrates a suitable use tracking element 156.

Activation status element 156.1 records whether or not the coupon is activated. Display status element 154.2 records the time, the location, and the number of times electronic coupon 123 has been displayed. The use of location records will become more apparent in a later described embodiment of electronic coupon system 10.

Similarly, transaction status element 156.3 records the time, the location, and number of times electronic coupon 123 has been redeemed. As previously described, the use of location records will become more apparent in a later described embodiment of electronic coupon system 10.

Activation status element 156.1, display status element 156.2, and transaction status element 156.3 may be used to calculate advertising fees charged to the merchant. This also will become more apparent in a later described embodiment of electronic coupon system 10.

Control element 158 includes a geographic element 158.1, offer lifetime element 158.2, offer condition element 158.3, and coupon identification element 158.4. FIG. 11 illustrates a suitable control element 158.

Geographic element 158.1 limits the display and use of electronic coupon 123 to a specific region. This feature will be become more apparent in a later described embodiment of electronic coupon system 10.

Offer lifetime element 158.2 limits the duration of the coupon with an expiration date.

Offer condition element 158.3 includes limitations such as restriction on beaming (i.e., copying) and hours or days when an offer is valid. In addition, offer condition element 158.3 includes information on how many times a coupon may be used or if it must be used a number of times before becoming available.

Coupon identification element 158.4 includes a unique identification number, a creation date, and an ultimate expiration date. Once a coupon expires, all elements are erased except for the identification number and the ultimate expiration date. If a consumer tries to reinstall the same coupon, the creation date of the reinstalled coupon can be compared with the ultimate expiration date of the original coupon to determine if the coupon is valid. Thus, coupon identification element 158.4 prevents the reinstallation of an encrypted coupon that is no longer available to the consumer.

In one embodiment of electronic coupon system 10, PDA 48 also retains a copy of use tracking element 156 of electronic coupon 123 after electronic coupon 123 expires. PDA 48 returns use tracking element 156 to client computer 44 the next time PDA 48 communicates with client computer 44. This process can occur automatically, i.e., initiated by electronic coupon application 106, without the consumer's intervention.

Thereafter when client computer 44 communicates with web server 42 via the Internet 50, web server 42 uploads the use tracking element 156 and saves it in use tracking database 74 (FIG. 4). Alternatively, client computer 44 can automatically, i.e., without the consumer's intervention, initiated a communication link with web server 42 to transfer tracking element 156. Copies of use tracking element in client computer 44 and web server 42 may be used to profile a consumer and tailor coupons to their preferences.

In addition, use tracking elements may be used to calculate advertising fees to the merchants. For example, a price structure for displaying, activating, and redeeming electronic coupons may be employed to charge advertising fees. In one embodiment, different levels of display, e.g., icon, text, and graphics, of electronic coupons may be further employed to calculate advertising fees.

In an alternative embodiment where PDA 48 has a communication link with the Internet through modem 102, PDA 48 returns a copy of use tracking element 156 to web server 42 the next time PDA 48 communicates with web server 42 via the Internet 50.

The details of encrypting electronic coupon 123 will now be disclosed. In one embodiment of electronic coupon system 10, web server 42 encrypts the elements of electronic coupon 123 using public key cryptography. Through encryption, the access rights of the parties to the elements of electronic coupon 49 are controlled to prevent fraud or deception in the electronic coupon transaction.

In public key cryptography, an encryption key is used to encrypt data while a complement decryption key is used to decrypt the data encrypted with the encryption key. In other words, the decryption key allows one to read a data written with the encryption key. A commercially available public key cryptography application is Pretty Good Privacy™ made by Pretty Good Privacy, Inc. of San Mateo, Calif. The user guide for Pretty Good Privacy™ is hereafter incorporated by reference in its entirety.

In this embodiment, coupon server application 60 on web server 42 and electronic coupon application 106 on PDA 48 include a cryptography application. Using the encryption application, coupon server application 60 generates pairs of encryption keys and decryption keys and assigns each pair of encryption and decryption keys to an element of electronic coupon 123. Each pair of encryption and decryption keys has one or more corresponding passphrases.

To use the encryption keys and decryption keys, a party (i.e., web server 42, the activation agent, the merchant, the consumer, and PDA 48) must enter a corresponding passphrase in the cryptography application. Thus, each party's ability to encrypt or decrypt, i.e., write or read, the elements of electronic coupon 123 can be controlled through the distribution (i.e., physical location) of the encryption and decryption keys. Furthermore, each party's ability to encrypt or decrypt can be controlled by the distribution of the passphrases for encryption keys and decryption keys. In one embodiment, a party's passphrase is embedded in the coupons server application and the

Alternatively, coupon server application 60 may generate and assigns pairs of encryption and decryption keys to the parties where only the parties know the corresponding passphrases. Thus, each party's ability to encrypt or decrypt, i.e., write or read, the elements of electronic coupon 123 can be controlled by selectively encrypting the elements of the electronic coupon and the distribution (i.e., physical location) of the encryption keys and the decryption keys.

Using either of the above methods, the final product is a system of access rights illustrated in FIG. 12. As FIG. 12 shows, web server 42 can read and write all elements of electronic coupon 123. The activation agent can read payload element 150 and activation element 154, and write to activation status of activation element 154.2 of activation element 154 and activation status 156.1 of use tracking element 156. The merchant can read payload element 150 and authentication element 152, and write available status element 152.2 of authentication element 152 and transaction status element 156.3 of use tracking element 156.

PDA 48 can read payload element 150, activation element 154, use tracking element 156, and control element 158, and write display status element 156.2 of use tracking element 156. The consumer can read payload element 150, available status element 152.2 of authentication element 152, activation status element 154.2 of activation element 154. The consumer can also read geographic element 158.1, offer life time element 158.2, and offer condition element 158.3 of control element 158.

As an alternative to using public key encryption, electronic coupon application 106 can use a system of password that grants access to the elements of coupon 123 to each parties. However, this system may be vulnerable to attack as the passwords are saved in the electronic coupon application 106, whereas in public key encryption, a write (i.e., encrypt) key for an element may not located on PDA 48.

In one embodiment of interactive coupon system 12, a merchant who wishes to submit specifications for an electronic coupon must register with web server 42 by providing billing information to web server 42. The billing information is used to charge the merchant for advertising fees associated with the display, activation, and redemption of electronic coupon 123 in electronic coupon system 10. As previously described, copies of use tracking element 156 transferred to client computer 44 and web server 42 may be used in the calculation of advertising fees.

The merchant may register with web server 42 through the Internet 50. In this embodiment, the merchant uses client computer 44 to log onto web server 42 to register. Each party to a coupon transaction may have different access rights depending on their role. The access rights are enforced by a system of cryptographic read and write keys, which enable each party to either, encode (write), decode (read) or both (read and write). In some cases a party's key may only give partial access to a read or write operation.

The server creates the coupon as authorized by the merchant. The server may read and write any area of the coupon except Use Tracking. The Use Tracking area may only be created empty, to reduce the possibility that a fictitious use record might be created. The Activation Agent may not exist in all use models. The role of this party is to activate a Coupon for use, typically within the context of a site containing many merchants (i.e. a shopping mall). This party may only write that the coupon has been activated in the Use Tracking area. The Activation Agent may view Activation area information to verify that the Coupon is valid for activation.

Merchant provides the user access to a good or service related to the coupon. The merchant may only write whether or not the coupon has been used to the use tracking area. In some cases this may result in a counter within the use tracking area being incremented. The counter is used when information within the control area indicates that the coupon may be used more than once or that the coupon must be used a number of times before a benefit is given.

If the coupon may only be used once (as indicated in the control area), the merchant key may be used to clear the available status in the authentication area. If the coupon may be used a number of times, the merchant key may used to clear the available status in the authentication area after the maximum number of uses has been reached (as indicated in the control area).

If the coupon must be used a number of times before it may be used to obtain a benefit; the merchant key may be used to set the available status after the minimum number of uses has been reached (as indicated in the control area). Once a coupon is made available in this way, it may become un-available again as described above.

The PDA is the device upon which the coupon resides. It has authority to only write display status events into the use tracking area. This information can include specifics on what conditions existed when the coupon was viewed as well as the type of viewing that occurred. Examples of conditions include time of day, location and what action caused the viewing to occur. Examples of the type of viewing include icon, text line and coupon face display. A series of entries may be made on the display status providing a history of the viewing of a coupon.

The consumer receives the good or service related to the coupon from the merchant, and may not write any area of the coupon. In addition, the user may only read whether or not the coupon is available from the authentication area, whether or not the coupon is active from the activation area and what restrictions apply from the control area.

FIG. 13 illustrates a flow chart of the interaction between the merchant using client computer 44 and web server 42 during merchant registration.

In action 202, client computer 44 establishes a communication link with web server 42 through the Internet 50.

In action 204, web server 42 transmits a merchant registration web page 210 to client computer 44. FIG. 13A illustrates a suitable merchant registration page 210. As FIG. 13A shows, the merchant is prompted for its name, mailing address, credit card number, a merchant ID and password for future access, a telephone number, a fax number, and a business type.

In action 206, the merchant enters registration information on the registration page and transmits the registration information to web server 42.

In action 208, web server 42 saves the billing information in merchant database 66 (FIG. 4).

Alternatively, as previously described, the merchant may submit registration information to the operators of web server 42 through the mail or the telephone.

In another embodiment of interactive coupon system 10, the merchant can submit the specifications of the electronic coupon through the Internet 50. In this embodiment, the merchant uses client computer 44 to log onto web server 42 to submit electronic coupon specifications.

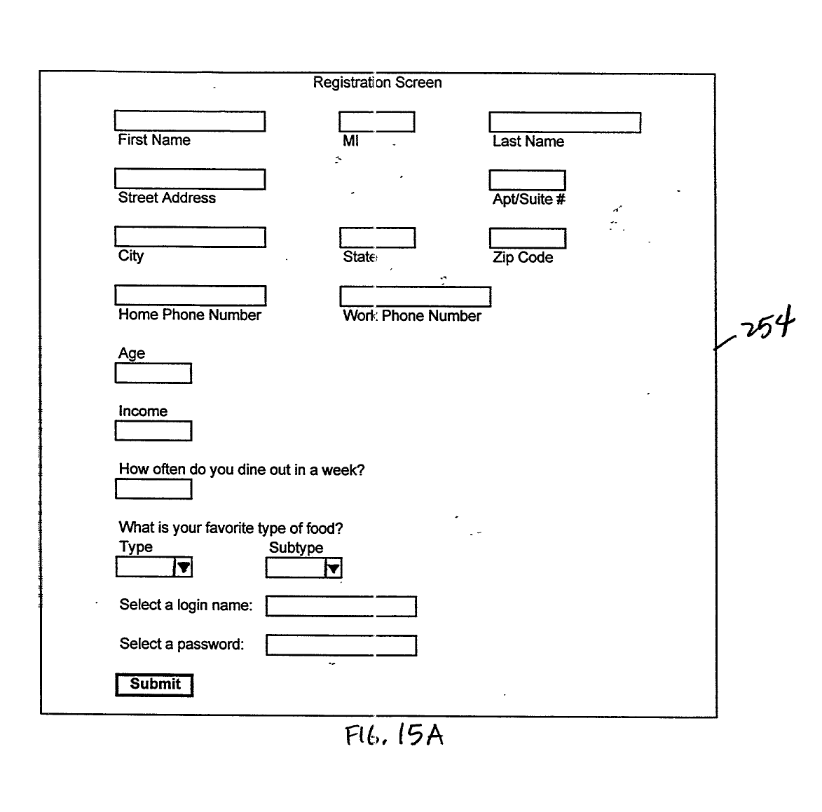

FIG. 14 illustrates a flow chart of the interaction between the merchant using client computer 44 and web server 42 during the submission of coupon specifications.

In action 220, client computer 44 establishes a communication link with web server 42 through the Internet 50. In action 220, merchant must enter its merchant ID and password.

In action 222, web server 42 transmits a coupon specification web page 228 to client computer 44. FIG. 14A illustrates a suitable coupon specification web page 228. Coupon specification web page 228 prompts the merchant for the name of the coupon, the graphics on the coupon, the text of the coupon, duration of the coupon, maximum number of use of the coupon, the number of times of use prior to discount, type and subtype of the coupon. As FIG. 14A shows, the merchant can type or use a drop-down menus in the various fields.

In action 224, the merchant enters coupon specifications on coupon specification page and transmits coupon specifications to web server 42.

In action 226, web server 42 creates an electronic coupon and saves the electronic coupon in coupon database 72 (FIG. 4).

Alternatively, as previously described, the merchant can submit coupon specifications to the operators of web server 42 through the mail or the telephone and the operators will enter coupon specifications into web server 42.

In one embodiment of interactive communication system 10, a consumer must register with web server 42 before web server 42 will transmit encrypted coupon 123 to client computer 44 or PDA 48. During registration, the consumer provides demographic information that allows web server 42 to better provide the consumer with electronic coupons that conforms with the consumer's preferences.

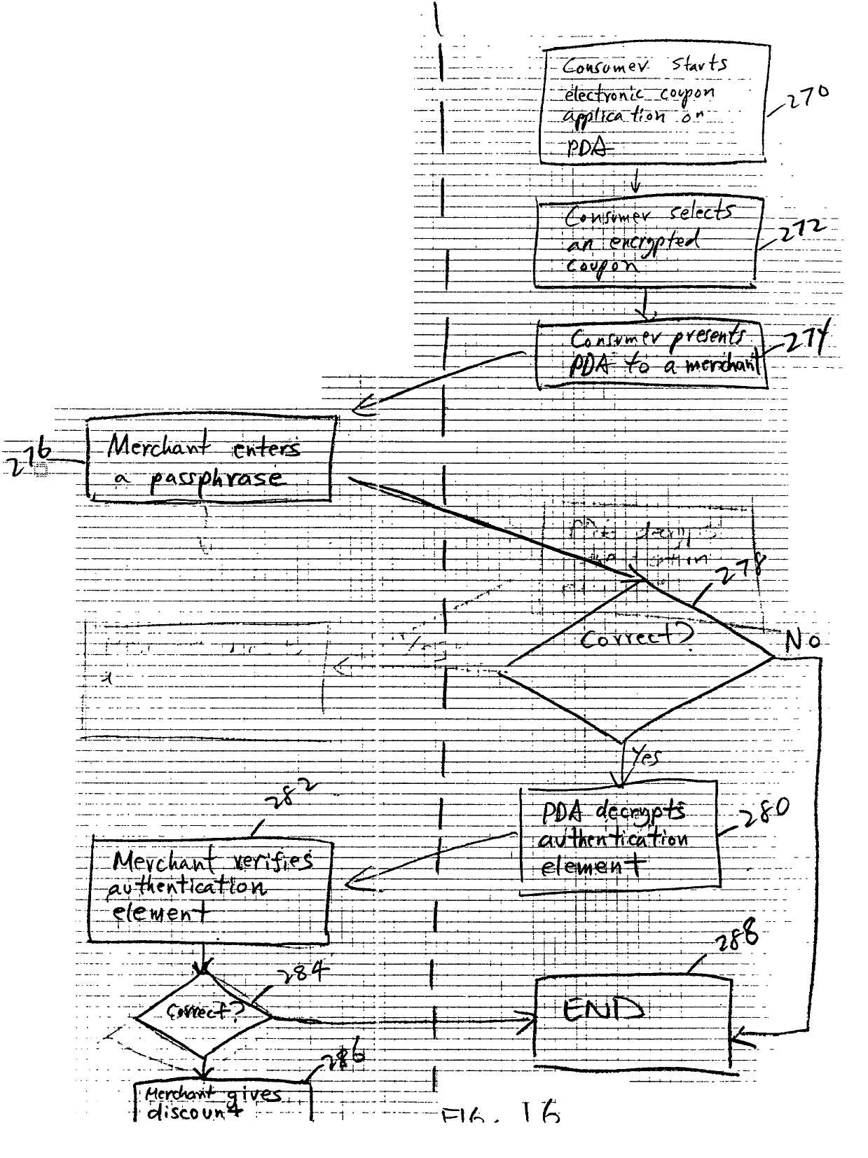

FIG. 15 illustrates a flow chart of the interaction among a consumer using client computer 44, web server 42, and PDA 48 during consumer registration.

In action 240, client computer 44 establishes a communication link with web server 42 on the Internet.

In action 242, web server transmits a consumer registration web page 254 to client computer 44. FIG. 15A illustrates a suitable consumer registration web page 254. Consumer registration web page 254 prompts the consumer for a name, address, telephone number, age, income, a user ID, a password, and demographic questions such as the consumer's favorite food.

In action 244, the consumer enters registration information on registration web page 254 and transmits the registration information to web server 42.

In action 246, web server 42 saves the registration information in consumer database 68 (FIG. 4).

In action 248, web server 42 transmits electronic coupon application 106 to client computer 44.

In action 250, client computer 44 transmits electronic coupon application 106 to PDA 48.

In action 252, the consumer installs electronic coupon application 106 on PDA 48.

Alternatively, if PDA 48 has a wireless modem, PDA 48 can register with web server 42 through the Internet 50.

In another embodiment, the consumer may receive electronic coupon application 106 through the mail or at promotional events. However, the consumer may still be required to register with web server 42 in order to gain access to electronic coupons stored on web server 42.

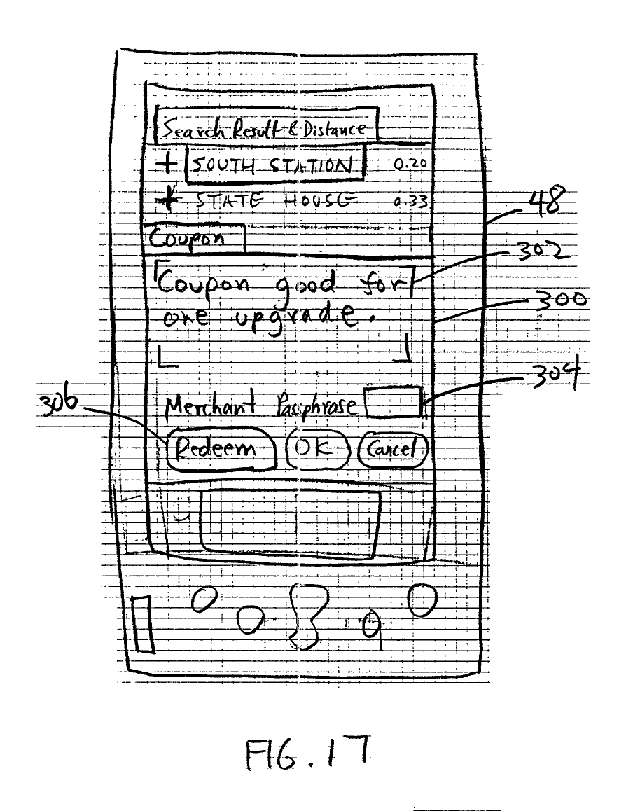

FIG. 16 illustrates a flow chart of the interaction between the consumer using electronic coupon application 106 on PDA 48 and the merchant during the redemption of an encrypted coupon 123.

In action 270, the consumer starts electronic coupon application 106 on PDA 48.

In action 272, the consumer selects an encrypted coupon from the electronic coupon application 106.

In action 274, the consumer presents PDA 48 to the merchant.

In action 276, the merchant enters a passphrase in PDA 48.

In action 278, electronic coupon application 106 determines if the passphrase is correct. If the passphrase is correct, the next action is 280. Otherwise, the next action is 288

In action 280, electronic coupon application 106 decrypts and displays authentication element 152.

In action 282, the merchant verifies the information contained in authentication element 152.

In action 284, if authentication element 152 is correct, the next action is 286. Otherwise, the next action is 288.

In action 286, the merchant gives the consumer the appropriate discount.

In action 288, electronic coupon application 106 ends the redemption process.

FIG. 16 may be modified to illustrate a flow chart of the interaction between the consumer using electronic coupon application 106 on PDA 48 and the activation agent during the activation of encrypted coupon 123.

| Action | Modification |
|---|---|
| 274 | Consumer presents PDA to an activation |
| | agent |
| 276 | Activation agent enters a passphrase |
| 280 | PDA decrypts activation element |
| 282 | Activation agent verifies activation |
| | element |
| 286 | Activation agent activates PDA |

In one embodiments of electronic coupon system 10, encrypted coupon 123 could be used repeatedly without limit. In another embodiment, encrypted coupon 123 could be used up to a specified amount of times. In yet another embodiment, encrypted coupon 123 must be redeemed a specified amount of times before a discount is provided by the merchant. As previously discussed, these conditions are specified in control element 158 of electronic coupon 123 and enforced by electronic coupon application 106.

In an embodiment of electronic coupon system 10, electronic coupon application 106 includes a map application that displays electronic maps from a map database, e.g., map database 110 (FIG. 4). This embodiment is hereafter referred to as the “coupon map system 298.”

In one embodiment of coupon map system 298, the coupon is linked to a geographic location on an electronic map. Whenever the map application displays the geographic location where the electronic coupon is linked, the map application also displays an icon representing the electronic coupon. To view more information about the electronic coupon, the consumer selects the electronic coupon from the display and the map application displays a screen with text and graphics concerning the electronic coupon.

Furthermore, the consumer can perform a coupon search on the map application. To search for a coupon, the consumer selects a type of coupon to search for on the map application. In addition, the consumer can narrow his or her coupon search by limiting the search for electronic coupons in his or her immediate vicinity by specifying a search radius. In one embodiment of coupon map system 298, PDA 48 includes a Global Position System (“GPS”) unit that automatically uPDAtes the consumer's current location. A suitable GPS unit is Earthmate™ made by DeLorme of Yarmouth, Me.

In one embodiment, the consumer access web server 42 from client computer 44 to transfer electronic coupons and electronic maps to client computer 44 and then to PDA 48. Once the consumer has registered with web server 42, client computer 44 may automatically download electronic coupons and electronic maps from web server 42 without the consumer's intervention.

A suitable map application included in electronic coupon application 106 is StreetSign™ 2.5 made by TrekWare Corporation of Wayne, Pa. The instruction manual for StreetSign™ 2.5 is hereby incorporated by reference in its entirety. StreetSign™ 2.5 is a vector-based mapping application for Palm computing platforms made by 3Com of Santa Clara, Calif.

StreetSigns™ 2.5 has a “SignPost” feature that allows a SignPost to be saved to a location on an electronic map based on its latitude and longitude. A SignPost is essentially an icon representing a location where a user has marked and named. Each SignPost is categorized by type, e.g., restaurant. Some types can be further categorized into SignPost subtypes, e.g., French restaurant.

In addition, the SignPost feature allows an “InfoBurst” to be assigned to a SignPost. InfoBurst includes information related to the SignPost such as its name, address, city, zip code, phone number, icon, and textual description. SignPost and InfoBurst entries are saved in coupon database 112 (FIG. 4) separate from map database 110 that holds the electronic map for StreetSigns™ 2.5.

StreetSigns™ 2.5 allows the consumer to search for a SignPost by type and subtype relative to the consumer's current location. StreetSigns™ also displays a SignPost icon whenever the location where the SignPost is saved to is displayed. The details of the general operation and user interface of StreetSigns™ are described in the instruction manual previously incorporated by reference and will not be repeated.

In this embodiment of coupon map system 298, web server 42 creates an electronic coupon in the form of a SignPost and an InfoBurst for StreetSign™ 2.5. FIG. 17 illustrates a suitable electronic coupon 300 in the form of an InfoBurst displayed on PDA 48. As FIG. 17 shows, electronic coupon 300 in the form of an InfoBurst includes a text 302 describing the coupon.

In this embodiment, web server 42 saves electronic coupon 300 in the form of a SignPost and an InfoBurst in a coupon database 112 (FIG. 4). As previously described, web server 42 can transfer the data, e.g., coupon database 112, to client computer 44 and client computer 44 can transfer the data, e.g., coupon database 112, to PDA 48. In an alternative embodiment, as previously described, web server 42 can transfer the data, e.g., coupon database 112, to PDA 48 if PDA 48 has a communication link to the Internet 50.

In another embodiment of coupon map system 298, web server 42 first creates electronic coupon 300 in the form of a SignPost and an InfoBurst for StreetSign™ 2.5 and then encrypts electronic coupon 300. In this embodiment, StreetSign™ 2.5 is modified to includes a cryptography application. As such, the modified StreetSign™ 2.5 requires activation agents and merchants to enter a passphrase so they can authenticate electronic coupon 300.

In this embodiment of coupon map system 298, electronic coupon 300 includes a merchant passphrase box 304 and a redeem button 306, as shown in FIG. 17. In addition, electronic coupon may also include an activation agent passphrase box (not shown) and an activate button (not shown).

In another embodiment of coupon map system 298, the map application is used to display the floor plan of a shopping center and the stores within the shopping centers. In this embodiment, the coupons are linked to stores within the shopping centers. Furthermore, the coupons may be linked to individual isles within the store. In this embodiment, client computer 44 are made available at the shopping center so that a consumer can link PDA 48 to client computer 44 to download electronic coupons and maps.

In another embodiment of coupon map system 298, the map application is used to display a city hosting a convention. Furthermore, the map application may be used to display the floor plan of the convention center where the coupons are linked to the display booths. In this embodiment, client computer 44 are made available at the convention so that a consumer can link PDA 48 to client computer 44 to download electronic coupons and maps. Furthermore, client computer 44 may be made available at an airport or a hotel in the proximity of the convention so that a consumer can readily download coupons and maps to his or her PDA 48.

In one embodiment of coupon map system 298, web sever 42 calculates advertising fees of merchants by the number of times an electronic coupon is displayed, activated, and used. Furthermore, advertising fees can be calculated by the types of display, such as one of a display of an icon, a display of graphics, a display of graphics, or any combination thereof.

One example for using system 10 (FIG. 1) is discussed below, and is merely illustrative and not limiting the scope of the invention.

The server creates the coupon according the specifications of the merchant and activation agent. Included in these specifications are the text and layout of the payload, the merchant authentication information, the activation authentication information (from the authentication agent) and the conditions of the offer for the control area. The coupon's use tracking is initialized to empty. In this example, the coupon is single use, requires activation and may only be used within 24 hours of activation and only by this specific consumer.

The merchant's encode key is used to write the payload, authentication and control areas. The activation agent's encode key is used to write the activation area. The server's encode key is used to clear the use tracking area. The consumers encode key is used to encrypt the payload (locking the coupon to the consumer).

At this point the coupon may also be linked to another database i.e. a map. After the coupon is packaged for transmission it is sent to the consumer (i.e. Ftp download). Any use tracking information residing in the PDA is uploaded at this point. When the consumer receives the coupon it is installed onto the PDA (i.e. Hotsync). Resident on the PDA is the consumer's decode key (installed by the server with applications software when the consumer was initially activated for coupons). This key allows the consumer to view the payload, available status from the authentication area, activation status from the activation area and offer restrictions from the control area.

The consumer presents his PDA with the payload displayed to the activation agent. The activation agent enters a pass phrase opening the activation area. Upon verifying that the activation information displayed indicates that the coupon is valid for activation, the agent clicks a box on the platform indicating that the coupon is active. This sets the activation status in the use tracking area. The activation time is also logged in the use tracking area for comparison with the expiration information in the control area.

The activation area closes and the activation agent hands the PDA back to the consumer. Note that this entire process could be performed using a wired or wireless link. The consumer presents his PDA with the payload displayed to the merchant. If the PDA detects that the expiration time has lapsed or that coupon is unavailable (redeemed previously) that information is displayed with the payload. The merchant may then decline to honor the coupon. If the payload of the coupon appears to be acceptable, the merchant enters a pass phrase opening the authentication area. Upon verifying that the authentication information displayed indicates that the coupon is valid for use, the merchant clicks a box on the platform indicating that the coupon has been redeemed. This sets the transaction status in the use tracking area.

The PDA runs the cryptographic and display routines. The PDA enables the payload to be displayed under the conditions specified in the control area and by requests from the consumer. It also logs each occurrence of display of the coupon in the use tracking area. The consumer's experience is that an offer was displayed either as a result of a request or automatically (i.e. Due to proximity to a business). The consumer decided to accept the offer. The consumer presented his PDA displaying the coupon at the entrance to the business (a step required only for some offers). Selected the merchandise covered by the offer and presented his PDA displaying the coupon to the merchant. The PDA retains the use tracking information for each coupon and returns this information when the consumer next accesses the server. This information is used to track the effectiveness of the coupon and to bill the advertiser (usually the merchant) accordingly. The use tracking information may also be used in some cases to prove that a coupon was redeemed and justify a credit to the consumer's account based on the offer.

If a coupon has been redeemed and it's control area indicates it may no longer be used, it is deleted and it's signature and expiration are kept within the PDA. This prevents a copy of the coupon from being re-installed in the PDA. When a coupon is subsequently loaded which has a creation date in the control area later than the expiration date of the signature, the signature and expiration date are discarded.

The following describes implementation software related to system 10 (FIG. 1). A coupon of the type illustrated in FIG. 6 (described above) is included, in one implementation in a record of the type illustrated below (and described in detail in file agent.h that is included the attached appendix).

| | |
|---|---|
| Subtype and Type | (e.g. Seafood Restaurant) |
| Name | (Red Lobster) |
| Address | (1482 Main St) |
| City | (Norfolk) |
| Country | (US) |
| Zip | (02056) |
| Phone | (508 123-4567) |
| Content | (varies) |
| Coord | (latitude, longitude) |
| Memo | (description field—a coupon in this case) |

In view of the description provided herein, software can be added to the files (that are related to “StreetSigns” and included in appendix A), to examine the memo field of records in this database for the existence of coupons. Also, software can be added for searching coupons by type and subtype and the point of interest (restaurant, hotel, bookstore etc), and such coupons can also be found manually by following the indicators on the street map.

A coupon may be redeemed when the merchant enters his account/ID in the appropriate field of the relevant coupon form on the PDA 48. Next time a HotSync is performed the PersonalDB file (of the type described in file AGENT.H and displayed by file AGENT.C, both in appendix A) on the local computer 44 is updated to reflect the current status of all coupons.

The software provided herewith can be compiled into an executable image by Code Warrior version 4, available from 3COM Corporation. This compiler creates an integrated developer environment on the desktop, similar to the Microsoft C/C++IDE (MSDEV). To build the source files provided herewith, it is necessary to include these files in a project under the Code Warrior IDE and issue the Make menuitem under the Project menubar item. The build process for Mapper (which software is provided in appendix B, and can be used to form a map database) is similar, but uses the Microsoft C/C++environment.

Numerous modifications and adapatations of the embodiments described herein will be apparent to a person of skill in the art in view of the enclosed description. Various such modifications and adaptations are encompassed by the attached claims.

What is claimed is:

1. A method for using a coupon comprising the acts of:
transmitting a coupon from a first computer to a personal digital assistant; and
displaying the coupon on the personal data assistant;
receiving a discount specified by the coupon from a merchant.

2. The method of claim 1, further comprising the act of:
generating the coupon by the first computer.

3. The method of claim 1, further comprising the act of:
encrypting the electronic coupon by the first computer.

4. The method of claim 3, further comprising the act of:
entering a passphrase into the personal digital assistant by one of a merchant and an activation agent.

5. The method of claim 4, further comprising the act of:
decrypting a portion of the electronic coupon by the personal digital assistant using the passphrase.

6. The method of claim 1, further comprising the act of:
restricting the use of the coupon to one of a time, a place, and a location by the personal digital assistant.

7. The method of claim 1, further comprising the act of:
restricting the number of times an electronic coupon can be used.

8. The method of claim 1, wherein the receiving occurs after the coupon have been displayed a number of times.

9. The method of claim 1, further comprising the act of:
generating the coupon by a second computer.

10. The method of claim 9, further comprising the act of:
transmitting the coupon by the second computer to the first computer.

11. The method of claim 9, further comprising the act of:
encrypting the coupon by the second computer.

12. A method for using a coupon comprising the acts of:
transmitting a coupon from a first computer to a personal digital assistant; and
displaying a map on the personal data assistant;
displaying the coupon on the personal data assistant;
receiving a discount specified by the coupon from a merchant.

13. The method of claim 12, further comprising the act of:
displaying an icon of the coupon on the map.

14. The method of claim 12, further comprising the act of:
searching for the coupon by a location on the map.

15. The method of claim 12, further comprising the act of:
searching for the coupon by type.

16. The method of claim 12, further comprising the act of:
generating the coupon by the first computer.

17. The method of claim 16, further comprising the act of:
encrypting the coupon by the first computer.

18. The method of claim 12, further comprising the act of:
generating the coupon by a second computer.

19. The method of claim 18, further comprising the act of:
encrypting the coupon by the second computer.

20. The method of claim 19, further comprising the act of:
transmitting the coupon by the second computer to the first computer.

21. The method of claim 12, wherein the map is one of a city, a conventional center, a shopping center, and a store.

22. A method for using a coupon comprising the acts of:
receiving a demographic information of a consumer;
selecting a first coupon, wherein the selecting is based on the demographic information received;
transmitting a first coupon to a personal digital assistant of the consumer from a first computer; and
displaying the coupon on the personal digital assistant.

23. The method of claim 22, further comprising:
transmitting the first coupon from a second computer to a first computer.

24. A method for using a coupon comprising the acts of:
selecting a first coupon for a consumer;
transmitting the coupon from the first computer to a personal digital assistant of the consumer;
displaying the coupon on the personal digital assistant; and
recording a display of the first coupon by the personal digital assistant.
selecting a second coupon for the customer by the first computer, wherein the selecting is based on the recorded display of the first coupon; and
transmitting the second coupon from the first computer to the personal digital assistant of the consumer.

25. The method of claim 24, further comprising the act of:
transmitting the first coupon and the second coupon from a second computer to the first computer.

26. A method for using a coupon comprising the acts of:
encrypting a first coupon;
transmitting the coupon to a personal digital assistant of a consumer;
decrypting a portion of the coupon by the personal digital assistant;
recording the decrypting of the first coupon by the personal digital assistant;
selecting a second coupon for the customer, wherein the selecting is based on the recorded decrypting of the first coupon;
transmitting a second coupon to the personal digital assistant of the consumer.

27. The method of claim 26, further comprising:
transmitting the first coupon and the second coupon from a second computer to the first computer.

28. A method for using a coupon comprising the acts of:
displaying a coupon on a personal digital assistant;
calculating advertising fees based on the number of times a coupon is displayed on the personal digital assistant.

29. A method for using a coupon comprising the acts of:
decrypting a portion of an encrypted coupon on a personal digital assistant;
calculating advertising fees based on the number of times a coupon is decrypted on the personal digital assistant.

30. A coupon system comprising:
a coupon;
a first computer having stored therein the coupon; and
a PDA having stored therein the coupon.

31. The coupon system of claim 28, wherein the personal digital assistant has stored therein a plurality of instructions for encrypting and decrypting the coupon.

32. The coupon system of claim 28, wherein the personal digital assistant has stored therein a plurality of instructions for displaying a map.

33. The coupon system of claim 30, wherein the map is one of a city, a conventional center, a shopping center and a store.
